(19) United States
(12) Patent Application Publication
(10) Pub. No.: US 2013/0180162 A1
(43) Pub. Date: Jul. 18, 2013

(54) BED BUG TRAP, CARBON DIOXIDE GENERATOR, AND TRAVEL KIT

(71) Applicant: Bug Elimination and Prevention Corporation, Waterloo (CA)

(72) Inventors: Kailash C. Vasudeva, Waterloo (CA); Satnam Singh, Kitchener (CA)

(73) Assignee: BUG ELIMINATION AND PREVENTION CORPORATION, Waterloo (CA)

(21) Appl. No.: 13/742,430

(22) Filed: Jan. 16, 2013

Related U.S. Application Data
(60) Provisional application No. 61/587,258, filed on Jan. 17, 2012.

(51) Int. Cl. A01M 1/02; A01M 1/10

(52) U.S. Cl. CPC A01M 1/023; A01M 1/103
USPC 43/123; 422/236

(57) ABSTRACT

The bed bug trap has a base, and a lid sealable against the base but leaving a gap in at least a portion around the periphery between the base and the lid. The base has a recess therein containing a glue pad, preferably on a removable and replaceable tray. The outer portion of the base is sufficiently textured for a bed bug to be able to climb into and enter the trap through the gap. A carbon dioxide generator is connectable to the trap. A heat pad may be clipped to the trap. A travel kit includes the bed bug trap and other items which may include the carbon dioxide generator, the heat pack, and other accessories.

### REFERENCE TO RELATED APPLICATIONS

This application is based on, and claims the benefit of, prior provisional patent application Nos. 61/587,258, 61/678,588 and 61/716,054, filed Jan. 17, 2012, Aug. 1, 2012 and Oct. 19, 2012 respectively.

### BACKGROUND OF THE INVENTION

This invention relates to a bed bug trap and optional carbon dioxide generator, used for the bed bug trap, and to a travel kit which includes the bed bug trap and may include the carbon dioxide generator and other accessories.

The recent expansion of bed bug populations, the geographical spread of same, and increased public awareness, have compounded to produce an ever-increasing need for bed bug traps. For people who travel, whether for business or pleasure, there is increasing reluctance to travel to areas where bed bug infestations are common, due to the ease which they can be brought home unintentionally, and increasingly there are few areas where bed bugs cannot be encountered either regularly or at least occasionally. There is therefore a need for readily portable bed bug traps, and for convenient kits which include such traps and facilitate their use.

It is well known that carbon dioxide is an attractant for bed bugs. Although there are many bed bug traps designed for trapping bed bugs, none of the current traps use carbon dioxide to lure bed bugs, and none control the carbon dioxide spreading around the trap so as to efficiently use carbon dioxide to attract the bed bugs.

Various carbon dioxide supplying devices and processes are known in other fields within the prior art. For example, the supply can be provided by gas dosing systems from gas cartridges which are pressure charged with carbon dioxide. But this method has the drawback that with decreasing gas pressure in the cartridge, the amount of carbon dioxide which is supplied per unit of time continuously decreases. In addition, a carbon dioxide supply system using gas cartridges requires a large amount of space and is aesthetically unsatisfactory.

For attracting bed bugs to a trap, whether for detection and/or elimination, there is a need for continuous, controlled and environmentally-friendly carbon dioxide generator that is specific to a bed bug trap. Satisfactory devices or methods for generating carbon dioxide for use in insect and/or bed bugs traps that are inexpensive, non-electrical, environmentally friendly, and adequately controllable have not been available to date.

There is therefore a need for a trap that is designed to effectively use carbon dioxide as a bed bug lure and also a device which can generate carbon dioxide in suitable volumes over a suitable time period, which can be combined with a bed bug trap, i.e. attached or attachable thereto.

### SUMMARY OF THE INVENTION

In view of the above, it is an object of this invention to provide a readily portable bed bug trap. Preferably, the trap has a structure that can use carbon dioxide as a bed bug lure and distribute the carbon dioxide in and around the trap.

It is a further object of the invention to provide a carbon dioxide generator, that may be specifically used with the trap, and optionally a kit of various accessories related to the bed bug trap, as will be set out in greater detail below.

According to one aspect of the invention, there is a bed bug trap having a base, and a lid sealing the base but leaving a gap in at least a portion around the periphery between the base and the lid, the base having a recess therein defining a pitfall and containing a glue pad or the like, the outer portion of the base being sufficiently textured for a bed bug to be able to climb into and enter the trap through the gap.

Preferably, the trap also includes an inlet for conveying carbon dioxide into the trap and for distributing the carbon dioxide to attract bed bugs to the trap. The inlet may connect with a carbon dioxide source.

The invention may also include a clip removably securing a heat generating pad on the trap, since bed bugs are also attracted to warmth.

The carbon dioxide source may be a carbon dioxide generator which has an outlet which can be connected to the inlet of the trap, for supplying carbon dioxide to the interior of the trap, from where it may flow out from the trap to attract bed bugs.

In one exemplary embodiment, the carbon dioxide generator includes: at least one sealed storage chamber at the bottom, charged with a chemical or a composition that can produce carbon dioxide by adding water or a solution, for example, a solid water soluble acid and/or a solid hydrogen carbonate salt; a water-fillable water chamber above the sealed storage chamber; a gas chamber above the water chamber; and an inlet for adding water or solution; a carbon dioxide outlet on the top of the gas chamber; and a water entry hole between the water chamber and storage chamber for water or solution to reach the chemicals/composition to produce carbon dioxide. Preferably, a foam or sponge layer separates the water chamber and the storage chamber so that water trickles in slowly, for controlled production of carbon dioxide.

According to another aspect of the invention, a travel kit is provided, in which the bug trap is packaged along with one or more of the following: a carbon-dioxide generating device, to aid in attracting bed bugs to the trap; heat generating means such a heating pad, again to aid in attracting bed bugs; a spray can of bed bug killing spray; a flashlight; a mirror; a magnifying glass; tweezers; a Ziploc® or similar plastic bag; and potentially other accessories.

Preferred embodiments of the invention may include the following advantageous effects: that the trap is small and connectable to a carbon dioxide source; that the trap controls the release of the carbon dioxide from and around the trap; that the release of carbon dioxide is carried out in a small space and in-situ; that the carbon dioxide release rate can be controlled; and in preferred embodiments where at least parts of the device are transparent, that the release of carbon dioxide is visible as bubbles through the water, to reassure the user that the carbon dioxide generation is working.

Further details of the invention will be described or will become apparent in the course of the following detailed description and drawings of specific embodiments of the invention, as examples.

### BRIEF DESCRIPTION OF THE DRAWINGS

Embodiments of the invention will now be described, by way of example only, with reference to the attached drawings, in which:

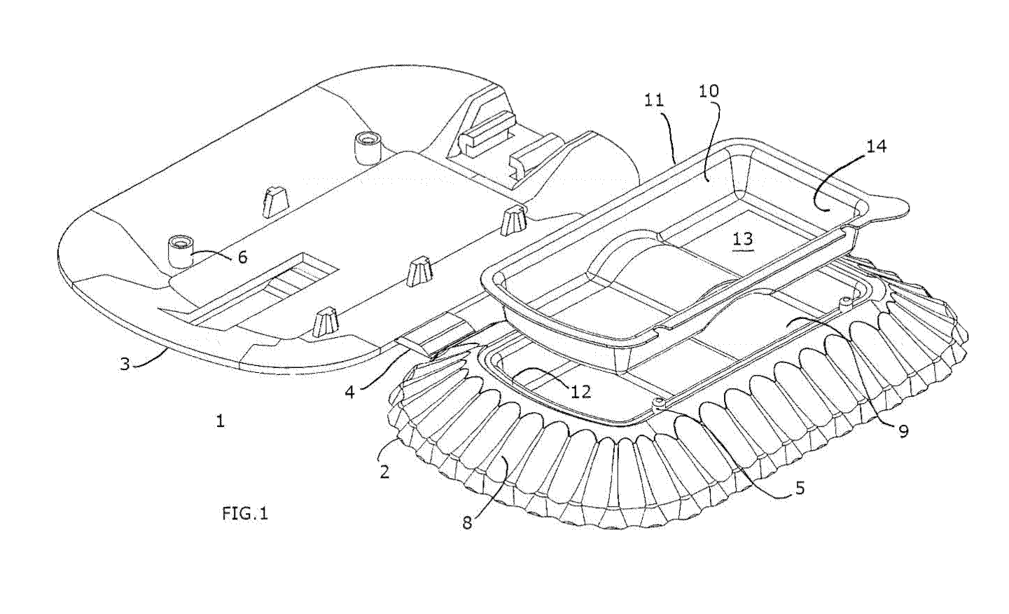

a. FIG. 1 is an exploded perspective view of an example of the trap, with its lid open; and

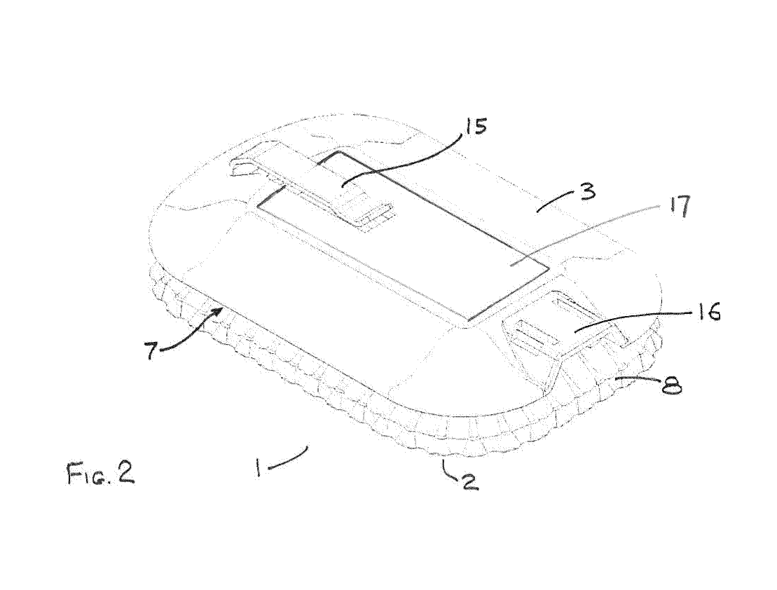

b. FIG. 2 is a perspective view of the trap of FIG. 1, with its lid closed.

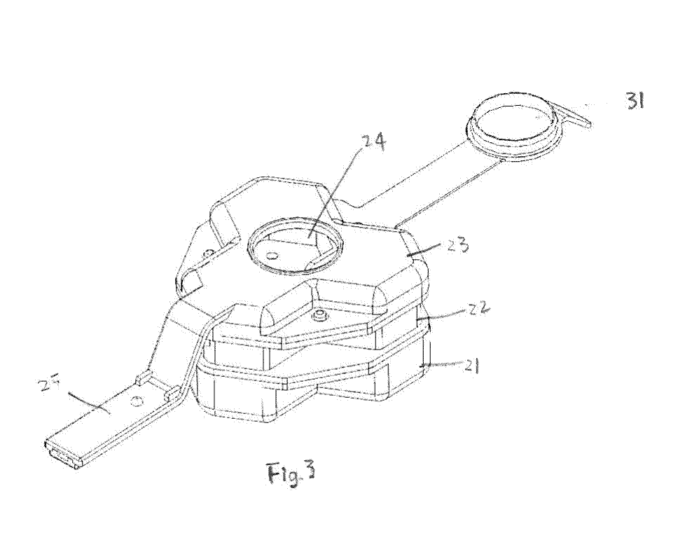

c. FIG. 3 is a perspective view of a first example of a carbon dioxide generator;

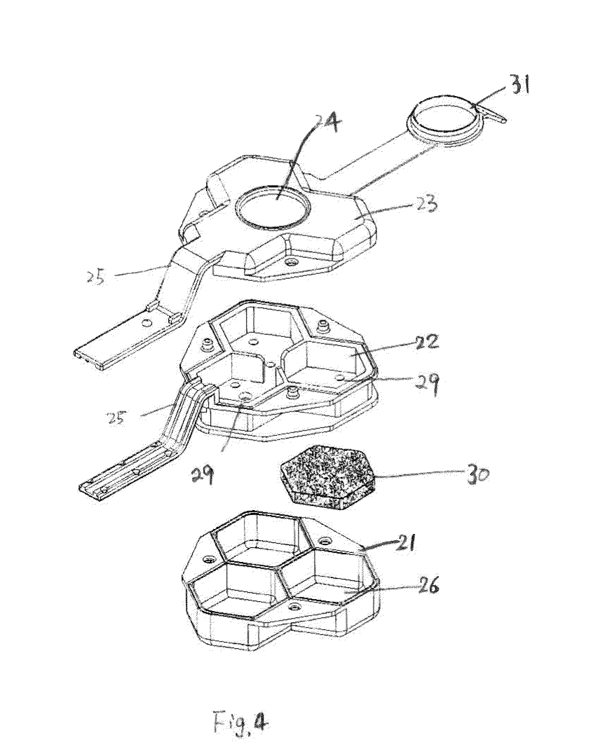

d. FIG. 4 is an exploded perspective view of the carbon dioxide generator of FIG. 3;

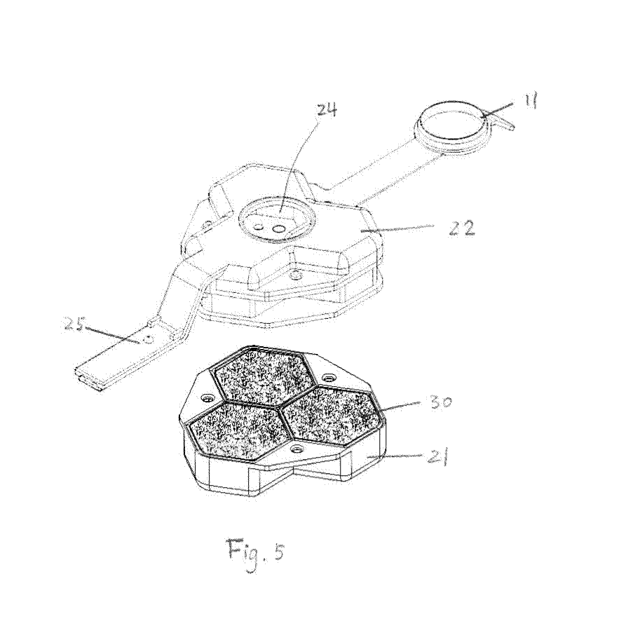

e. FIG. 5 is an exploded view of an alternative embodiment of the carbon dioxide generator (in which the water chamber and gas chamber are one piece);

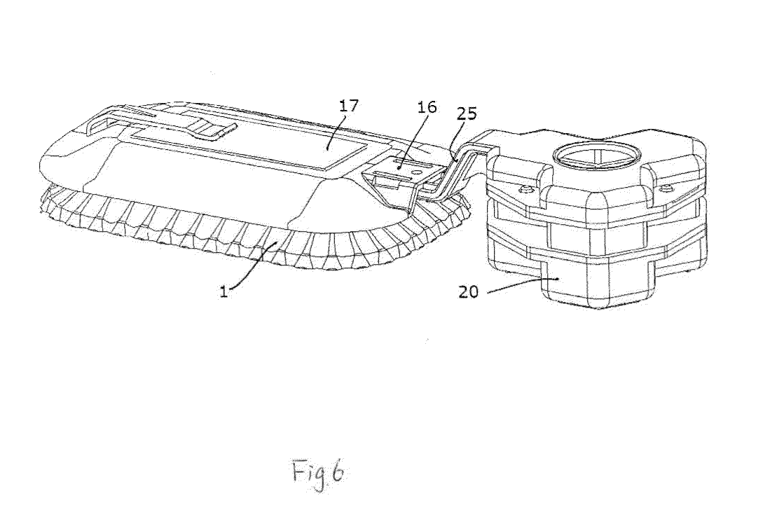

f. FIG. 6 is a perspective view of the trap combined with a carbon dioxide generator; and

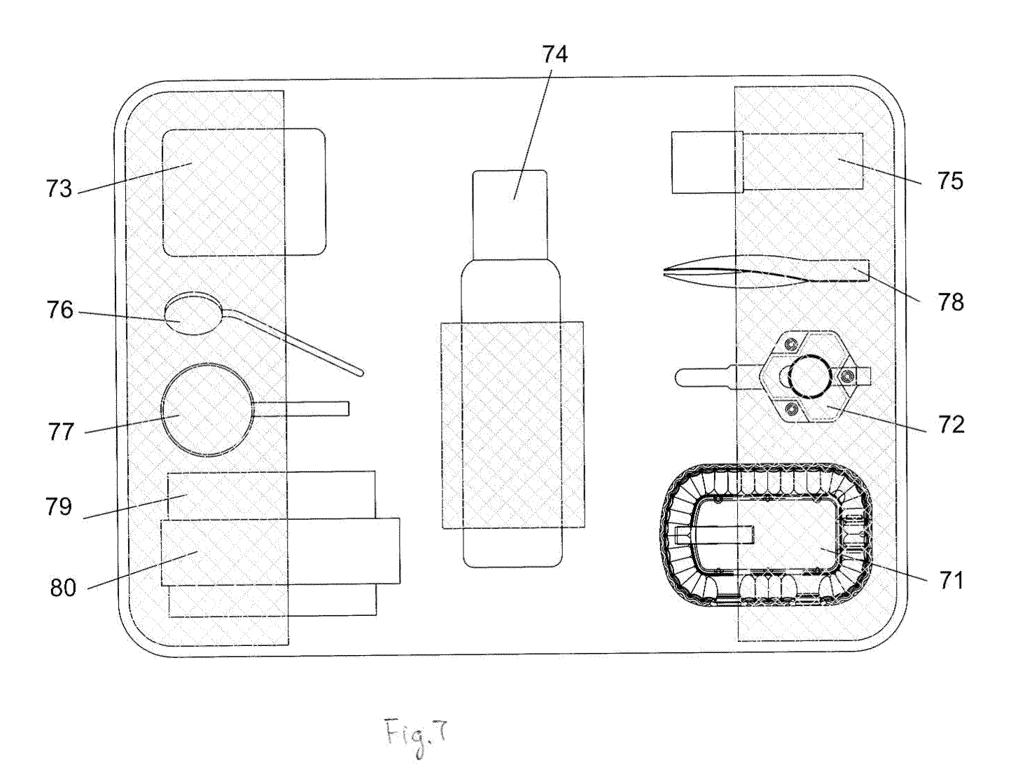

g. FIG. 7 is an view of example of travel kit including the trap and the carbon dioxide generator.

### DETAILED DESCRIPTION

### Bed Bug Trap

FIGS. 1 and 2 show an example of the bed bug trap 1. The trap is made from a suitable plastic and includes a base 2 and a lid 3. The lid is preferably but not necessarily connected to the base by a living hinge 4. The lid and the base snap together via posts 5 on the base, engaging cylindrical projections 6 on the lid. The cylindrical projections also act as spacers, to provide a peripheral gap 7 between the base and the lid for the bed bugs to enter the trap. While the lid is closed, the whole trap is sealed except for the peripheral gap 7. The outer edges and outer surface 8 of the base are angled and textured, defining a ramp in effect, so that bed bugs can readily climb the ramp. It is well known that bed bugs readily climb surfaces which are sufficiently textured, though they cannot climb smooth surfaces.

The base includes a recess 9 which acts as a pitfall. The recess can have a glue pad 13 or the like mounted on the bottom thereof to capture bed bugs, but preferably the glue pad is in a removable and replaceable tray 10 instead. The tray fits into the recess such that the outer lip 11 of the tray is approximately flush with the adjacent surface of the base, so that bed bugs can readily pass across the interface. Preferably the recess 9 has a notched edge 12 to receive the outer lip of the tray, to achieve a flush fit. The glue pad 13 or the like is mounted on the bottom of the tray. The inner side walls 14 of the recess or tray are sufficiently angled and sufficiently smooth that a bed bug, once it has fallen into the recess or tray from the edge thereof, cannot climb out. Of course, the recess or tray must should be sufficiently deep so that the bed bug cannot simply walk out if not immediately caught by the glue pad. In this example, the tray is approximately 8 mm deep. Obviously it could be more than 8 mm deep. If it is less than 8 mm deep, it might still work, but there is a risk that bed bugs could escape before being captured on the glue pad.

The glue pad also ensures that the bed bug will be secured, and cannot simply fall out or climb out when the trap is moved about or removed.

The lid 3 is provided with an inlet to input carbon dioxide as bed bug lure for the trap. The inlet could be a receptacle 16, to connect with an outlet (spout) of a carbon dioxide source, and at the same time to hold it in place. When the lid is closed, the receptacle 16 is just above the base. The whole trap is sealed except for the peripheral gap 7. Therefore, carbon dioxide coming from receptacle 16 diffuses in the trap and is released to the surrounding area of the trap only through the peripheral gap 7. With this structure of the trap, carbon dioxide is retained in the trap except for that which overflows and exits via the peripheral gap 7. From the area outside the trap and to the interior of the trap, a concentration gradient of carbon dioxide is thus formed. Bed bugs pursuing carbon dioxide thus can be easily attracted to the interior of the trap. Therefore, the structure of the trap can efficiently use carbon dioxide and at the same time effectively trap bed bugs.

Normally, adult bed bugs are about 6 millimeters long, 5-6 millimeters wide. Therefore, the peripheral gap 7 is about 5-10 mm wide, which is wide enough for bed bugs to climb in. The relatively small gap keeps the carbon dioxide in the trap and releases it to the surroundings slowly, so as to form a concentration gradient of carbon dioxide. If the peripheral gap 7 is too wide, carbon dioxide input to the trap cannot be kept in the trap, releasing to the surroundings too quickly. Therefore in some embodiments the peripheral gap 7 could be made effectively smaller by having it extend only around a portion of the periphery of the base and the lid.

FIGS. 1 and 2 show the inlet or the receptacle 16 on the lid. But obviously it can be anywhere on the trap, for example on the bottom or the sides of the base. Preferably, the inlet or the receptacle 16 can convey carbon dioxide right to the middle of the trap. Since carbon dioxide is heavier than air, it is preferable to be on the lid and just above the base.

Preferably, at least the lid or a portion of the lid is transparent or partially transparent, so that the user can readily see if there is a bed bug or bed bugs in the trap. If there is a bed bug, then the user can snap open the trap, and remove and dispose of the tray, replacing it with a new one.

Preferably, the trap also includes one or more additional features to attract any bed bugs to the trap, to increase the likelihood of successfully trapping them, and/or to provide even greater peace of mind. In a preferred embodiment, for example, as seen in FIG. 2, the lid may be provided with a clip 15 or some other suitable means. A heat-generating package 17, such as those commonly used for warming hands or toes in winter, can be activated and clipped to the trap using this clip, it being known that bed bugs are attracted to warmth. Or a chemical attractant can also be included in the trap area, such as on the tray or on the glue pad. The flow of carbon dioxide from the trap will act as a carrier for the chemical attractant, so that it is also emitted from the trap.

### Carbon Dioxide Generator

FIGS. 3 and 4 show a first example of a carbon dioxide generator. The carbon dioxide generator includes: a sealed storage chamber 21 at the bottom, a water chamber 22 above the sealed storage chamber 21, and a gas chamber 23 above the water chamber; and a water inlet 24 and an carbon dioxide outlet 25 on the top of the gas chamber 23. The sealed storage chamber 21 is divided into three cells 26, each cell 26 being charged with solid hydrogen carbonate salt or carbonate salt and/or solid water soluble acid. A piece of sponge 30 covers the composition in each cell. Each cell 26 and the water chamber 22 are connected by two holes 29.

Three cells are shown in FIG. 4, as an example. However, the number of cells can be adjusted according to the size of the sealed storage chamber 21 and the volume of carbon dioxide desired to be produced. In some embodiments, just one cell could be provided, though it is preferable to have two or more so that an initial burst of carbon dioxide can be provided by having one or more cells producing carbon dioxide at different rates.

Each cell can have one or more holes for water to pass down from the water chamber. The size and number of holes can be varied as desired, according to the desired carbon dioxide production rate vs. time profile.

In this example, the sealed storage chamber is charged with baking soda (NaHCO3) and citric acid. Preferably, the ratio of hydrogen carbonate salt to solid acid is the chemical stoichiometric ratio.

In another example, the sealed storage chamber is charged with baking soda, and to produce carbon dioxide, citric acid solution is added to the generator from the inlet.

However, it should be clearly understood that any suitable composition or chemicals that can produce carbon dioxide by adding water or a solution can be used. For example, the hydrogen carbonate salt can be NaHCO3, CaHCO3, and MgHCO3. The solid water soluble acid can be citric acid, tartaric acid, citric acid, alpha hydroxy acid. Preferably, the hydrogen carbonate salt is soda (NaHCO3) and the solid water soluble acid is citric acid. Since soda and citric acid are domestic products, they are safe for use anywhere. The hydrogen carbonate salt or carbonate salt can react with the acid to produce carbon dioxide. The generator can be charged with any carbonate salt or hydrogen carbonate salt, or acid. In order to produce carbon dioxide, water or acid or salt can be added through the inlet and carbon dioxide then can be produced.

To generate carbon dioxide, water or a solution (such as citric acid solution or carbonate salt) can be added through the water inlet 24 to the water chamber 22. By gravity, water or solution seeps into the sealed storage chamber through the holes 29 on the top of the cells 26 and the sponge 30, to contact the chemicals or composition in the cell 26. The resulting reactions generates carbon dioxide which is released through holes and gets through the water chamber 22 and then the gas chamber 23 and is released through the carbon dioxide outlet 25. Bubbles of carbon dioxide can be seen in the water chamber 22 by making the water chamber transparent. Without seeing these bubbles, the user would not know if carbon dioxide was being produced, since carbon dioxide gas has no color or smell. This feature therefore provides the user with confidence that the device is working to produce carbon dioxide.

As shown in FIGS. 3 and 4, a piece of sponge 30 formed to the same shape of the cell 26 is used in every cell to cover the composition. The thickness and porosity of the sponge 30 can be adjusted according to the rate of water desired. Typical thicknesses may be in the range of 0.5 mm to 2 cm, for example. The use of sponges can also help to hold the chemical/composition in place for storage and to protect it from moisture in the air in order to prevent its reaction. But it should be understood that the generator can also work without a sponge 30, for example by using sufficiently small holes to provide slow water entry, and/or by using compositions which dissolve very slowly to produce the carbon dioxide.

As shown in FIGS. 3 and 4, the sealed storage chamber 21, the water chamber 22 and the gas chamber 23 are mounted together by screws, but obviously they can be mounted together by any other conventional means, such as heat melting, glue, ultrasonic welding, etc.

A second example of the carbon dioxide generator is illustrated in FIG. 5. The carbon dioxide generator includes: a sealed storage chamber 21 at the bottom and a water chamber 22 at the top of the sealed chamber 21. There is a water inlet 24 and a carbon dioxide outlet 25 on the top of the water chamber 22. The sealed storage chamber 21 is divided to three cells 26, each cell 26 being charged with a suitable composition as previously described. The cells may be covered with sponge as previously described. Each cell 26 and the gas chamber 22 are connected by holes 29.

Carbon dioxide generation is essentially as described previously. However, in this example, there is no separate gas chamber. The water chamber also works as a gas chamber and carbon dioxide can be released from there. In this example, sponges are shown in FIG. 4, but they are not necessary.

The carbon oxide outlet 25 as shown in FIGS. 3 and 5 is a straight conductor, which can be inserted and locked into the receptacle 16 of the trap as shown in FIG. 2.

With above structures, the generator can produce carbon dioxide in a controlled rate and flow, directly to the bed bug trap. There is no need for any complicating components such as a valve and flow meter or the like.

Combination of Bed Bug Trap with Carbon Dioxide Generator

FIG. 6 shows the bed bug trap combined with the carbon dioxide generator. The carbon dioxide outlet 25 of the carbon dioxide generator 20 is inserted into the receptacle 16 of the bed bug trap 1. The cross-sectional shape of the outlet 25 is matches the receptacle 16, so that there is little or no carbon dioxide leakage at the connection area. To be well secured to the receptacle 16, the outlet 25 could be an rigid rectangular shape as shown, and can extend into the middle of the trap. Also, as shown in FIG. 6, the height of the outlet to the bottom of the generator is same to the height of receptacle 16 of the trap to the bottom of the trap, therefore, they can be mounted together to be used at same location.

To aid in attracting bed bugs to the trap, an optional heat pad 17 can also used. As shown in FIG. 6, a heat-generating package 17 can be attached to the trap by the clip 15. It can work as a heat lure for attracting bed bugs to the trap. The combination of bed bug trap with carbon dioxide generator can work without the heating pad.

For detecting bed bugs, a removable tray 10 with glue paper is placed in the trap and the lid is closed; the outlet 25 of the generator in inserted into the receptacle 16, water is added to the generator through the water inlet and the lid for the generator is closed. Carbon dioxide is generated in the generator and comes out of the generator through the outlet 25, eventually entering the trap and overflowing from the gap to the outer wall of the base and to the surroundings. Bed bugs attracted by carbon dioxide crawl to the trap and climb on the ramp and through the gap, where they fall onto the tray, and eventually are captured by the glue pad.

It can be seen that the combination of the trap with the carbon dioxide generator can be used as bed bug detector. It is easy to use, and also it is very portable. Since the carbon dioxide generator can produce a continuous and well-controlled release of carbon dioxide, there is no need for any other equipment to adjust the flow or pressure of carbon dioxide. The combination of the trap with the carbon dioxide generator is simple and low cost.

It should be apparent that any form of connection between the bed bug trap and carbon dioxide generator could be used. It should be equally apparent that no connection is required at all, either for the heat-generating package or for the carbon dioxide generating module, as long as they are placed in close proximity to the trap. However, the connecting means provide a convenient way of handling these various elements and ensuring suitable positioning, as well as having carbon dioxide released from the trap, not just near it.

Although the bed bug trap of the invention could be used anywhere, it is conceived as being particularly convenient for travelers. On checking into a hotel, for example, the person could leave one or a number of the traps in key locations where bed bugs tend to congregate, for example near baseboards and on or in the bedding near the pillow. Later, when ready for bed, the person could check the traps for bed bugs. If there are no bed bugs in the traps, presumably the person could then sleep with greater peace of mind.

### Travel Kit

According to another aspect of the invention, a travel kit is supplied, in which the bed bug trap is packaged along with one or more of the following: a carbon-dioxide generating device, to aid in attracting bed bugs to the trap; heat generating means such as heating pads, again to aid in attracting bed bugs; a spray can of bed bug killing spray; a flashlight; a mirror; a magnifying glass; tweezers; a Ziploc® or similar plastic bag; and potentially other accessories.

As showing in FIG. 7, a travel kit includes: a bed bug trap 71 of the invention; a carbon dioxide generator 72 of the invention, heat generating means, such as heating pad 73, for attracting bed bugs to the trap; a bed bug spray can 74; a flashlight 75, to facilitate looking for bed bugs, a mirror 76; a magnifying glass 77; tweezers 78; a Ziploc® or similar plastic bag 79 and gloves 80.

With this travel kit, a traveler can be well prepared for dealing with potential bed bug concerns in a hotel. For example, when he or she arrives at a hotel, he or she can use the trap to detect if there are any bed bugs in the hotel. With the help of the carbon dioxide generator and the heat pad, bed bugs can be quickly detected, for example within several hours.

If one or more bed bugs are found, then the person may have the option of requesting a different room, or failing that, may rely on additional elements of the kit of the invention, namely one or more of the following: a flashlight, to aid in searching for bed bugs in suspected locations; a mirror, for the same purpose; a magnifying glass, for the same purpose; tweezers for handling dead or living bed bugs; a Ziploc® or similar plastic bag for disposing of bed bugs; and a bed bug killing spray for when and if additional bed bugs are found.

It will be evident to those knowledgeable in the field of the invention that many variations on the examples described above are conceivable within the scope of the invention. It should therefore be understood that the claims which define the invention are not restricted to the specific examples(s) described above. Possible variations include, for example, that a removable glue pad or the like could be placed in the recess 9 instead of within the removable tray 10, with the side walls of the recess being sufficiently deep and smooth to prevent the bed bugs from climbing out.

As another alternative, the glue pad or the like could be secured to the bottom of the recess, and the entire trap could simply be disposed of when a bed bug is found in it.

Further variations may be apparent or become apparent to those knowledgeable in the field of the invention, within the scope of the invention as defined by the claims which follow.

1. A bed bug trap, comprising a base, and a lid securable to the base but leaving a gap in at least a portion around the periphery between the base and the lid, the base having a recess therein containing a glue pad or the like, the outer portion of the base being sufficiently textured for a bed bug to be able to climb into and enter the trap through said gap.

2. A bed bug trap as in claim 1, having an inlet connectable to an outlet from a carbon dioxide generator.

3. A bed bug trap as in claim 1, wherein a clip is provided on the trap to secure a heat generating means thereto.

4. A bed bug trap as in claim 2, wherein a clip is provided on the trap to secure a heat generating means thereto.

5. A bed bug trap as in claim 1, wherein said glue pad is mounted on a removable and replaceable tray, said tray being configured to fit in said recess.

6. A bed bug trap as in claim 2, wherein said glue pad is mounted on a removable and replaceable tray, said tray being configured to fit in said recess.

7. A bed bug trap as in claim 3, wherein said glue pad is mounted on a removable and replaceable tray, said tray being configured to fit in said recess.

8. A bed bug trap as in claim 4, wherein said glue pad is mounted on a removable and replaceable tray, said tray being configured to fit in said recess.

9. A bed bug trap as in claim 2, in combination with a carbon dioxide generator.

10. A bed bug trap as in claim 4, in combination with a carbon dioxide generator.

11. A bed bug trap as in claim 6, in combination with a carbon dioxide generator.

12. A bed bug trap and carbon dioxide generator in combination as in claim 9, wherein the carbon dioxide generator comprises: a storage chamber at a lower portion thereof, which is charged with a composition that can produce carbon dioxide by adding an appropriate liquid; a liquid chamber above the storage chamber; a liquid inlet and a carbon dioxide outlet at an upper area of the liquid chamber; the sealed storage chamber and the liquid chamber being connected by at least one hole which permits the liquid to slowly enter the storage chamber from the liquid chamber and carbon dioxide to escape from the storage chamber to the liquid chamber and thence to the carbon dioxide outlet.

13. A combination as in claim 12, further comprising a sponge layer between said liquid chamber and said storage chamber.

14. A combination as in claim 12, where the storage chamber is divided into at least two cells.

15. A combination as in claim 14, wherein each at least one cell has a sponge layer between said liquid chamber and said cell.

16. A combination as in claim 15, where at least two cells have a said sponge layer, and at least two different cells have different sponge thicknesses.

17. A combination as in claim 14, where the size or number of holes differs between cells.

18. A combination as in claim 12, comprising a gas chamber above the liquid chamber.

19. A carbon dioxide generator comprising a storage chamber at a lower portion thereof, which is charged with a composition that can produce carbon dioxide by adding an appropriate liquid; a liquid chamber above the storage chamber; a liquid inlet and a carbon dioxide outlet at an upper area of the liquid chamber; the sealed storage chamber and the liquid chamber being connected by at least one hole which permits the liquid to slowly enter the storage chamber from the liquid chamber and carbon dioxide to escape from the storage chamber to the liquid chamber and thence to the carbon dioxide outlet.

20. A kit containing a bed bug trap as in claim 1, packaged together with at least one item selected from the group consisting of the following items:
a carbon dioxide generator;
a heat generating means;
a spray can of bed bug killing spray;
a flashlight;
a mirror;
a magnifying glass;
tweezers;
a plastic bag; and
gloves.
